(19) United States
(12) Patent Application Publication
(10) Pub. No.: US 2019/0150653 A1
(43) Pub. Date: May 23, 2019

(54) High-Speed Energy Saving Container Apparatus

(71) Applicants: Kuang-Tsung Tseng, Taoyuan City (TW); Po-Hsun Tseng, Taoyuan City (TW)

(72) Inventors: Kuang-Tsung Tseng, Taoyuan City (TW); Po-Hsun Tseng, Taoyuan City (TW)

(21) Appl. No.: 15/869,085

(22) Filed: Jan. 12, 2018

(30) Foreign Application Priority Data
Nov. 20, 2017 (TW) 106140149

(51) Int. Cl. A47J 27/21

(52) U.S. Cl. CPC A47J 27/21166

(57) ABSTRACT

A high-speed energy saving container apparatus includes a vertical container unit. The vertical container unit is formed of a chamber and includes a bottom portion formed underneath thereof. The bottom portion thereof is formed of at least one heat accumulation recess thereon, and an outer edge of each one of the heat accumulation recess includes a thermal conductive shield extended upward into the chamber. Accordingly, the bottom portion and the thermal conductive shields are able to advantageously increase the heating surface area of the chamber.

### TECHNICAL FIELD OF THE INVENTION

The present invention is related to a high-speed energy saving container apparatus, in particular, to a high-speed energy saving container apparatus having a vertical container unit for receiving and heating water, and the internal of the vertical container is installed with a thermal conductive shield for increasing the water heating surface area.

### DESCRIPTION OF THE PRIOR ART

First, please refer to FIG. 1, showing a known cooking bucket comprising a cooking bucket 10 for heating a great amount of water A0, a furnace base 20 arranged underneath the water cooking bucket 10, and a furnace flame unit 30 for heating the cooking bucket 10 arranged on top of the furnace base 20. When the furnace flame unit 30 is turned on, the water contained inside the cooking bucket 10 is heated until the water boils, following which the furnace is turned off or turned to smaller flame to control its temperature.

For the use of large amount of boiled water A0, it often takes place in beverage stores for use of such boiled water A0, kitchen water A01 in schools or restaurants, and the water A0 used in preparing meat by butchery shops. Typically, a bucket of boiled water A0 shall be of the volume greater than six liters to satisfy the economic purpose of use. A conventional cooking bucket 10 generally has a volume of 100 liters, and the boiling process of such large amount of water A0 requires approximately 120˜250 minutes; consequently, it is known that significant period of time is required for boiling the water A0 and a great amount of fuel and energy can be wasted (the level of energy consumption for beverage stores, schools and restaurant kitchens, butchery shops are not indicated).

Accordingly, the during the boiling of water A01 of currently existing cooking bucket 10, a large amount of fuel is wasted due to low thermal conductivity such that the boiling time is long. As a result, there is a need to shorten the boiling time in order to save the energy and fuel used.

### SUMMARY OF THE INVENTION

In view of the above, it is known that a conventional cooking bucket consumes a great amount of energy due to its low thermal conduction efficiency and long period of cooking time. Accordingly, the inventor of the present invention seeks to provide a novel solution to improve the water boiling method after years of research and development. Accordingly, an objective of the present invention is to increase the heat transfer area and the flame height in order to increase the potential energy heating points and the kinetic energy of fluid.

To achieve the aforementioned objectives, the present invention provides a high-speed energy saving container apparatus, comprising a vertical container unit having a chamber formed therein and a bottom portion formed underneath thereof. The bottom portion is formed of at least one heat accumulation recess thereon, and an outer edge of each one of the heat accumulation recess includes at least one thermal conductive shield extended upward into the chamber.

In addition, the bottom portion of the high-speed energy saving container apparatus further comprises at least one column formed thereon and arranged uniformly to circumference the bottom portion, and a lower side of the bottom portion further comprises the heat accumulation recesses uniformly distributed thereon to circumference the bottom portion. Therefore, each of the heat accumulation recesses and each of the thermal conductive shields together form the column.

The objective of the present invention is to arrange a plurality of protruding heat conductive shields inside the vertical container unit in order to utilize the heat conductive shields to increase the heat transfer surface as well as to increase the height of the flame; thereby increasing the potential energy thermal point and increasing the fluid dynamic energy such that the boiling point of the liquid inside the container unit can be reached swiftly.

### BRIEF DESCRIPTION OF THE DRAWINGS

FIG. 1 is a schematic view of a known cooking bucket;

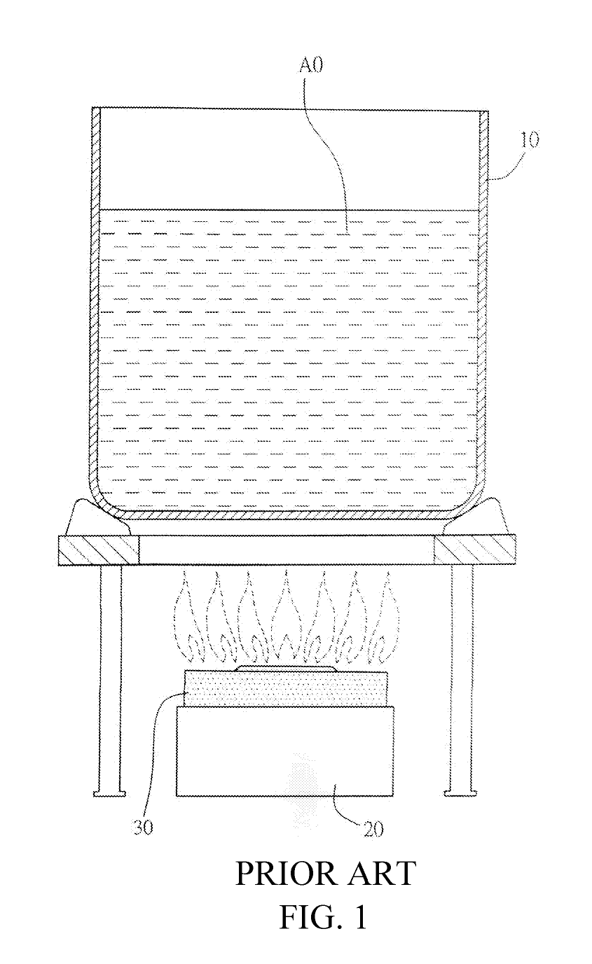

FIG. 2 is a perspective view of the high-speed energy saving container apparatus of the present invention;

FIG. 3 is a cross sectional view of the high-speed energy saving container apparatus of the present invention;

FIG. 4 is a top view of the high-speed energy saving container apparatus of the present invention;

FIG. 5 is a schematic view showing the high-speed energy saving container apparatus of the present invention equipped with a foot stand; and

FIG. 6 is a schematic view showing the heating state where the high-speed energy saving container apparatus of the present invention.

### DETAILED DESCRIPTION OF THE PREFERRED EMBODIMENTS

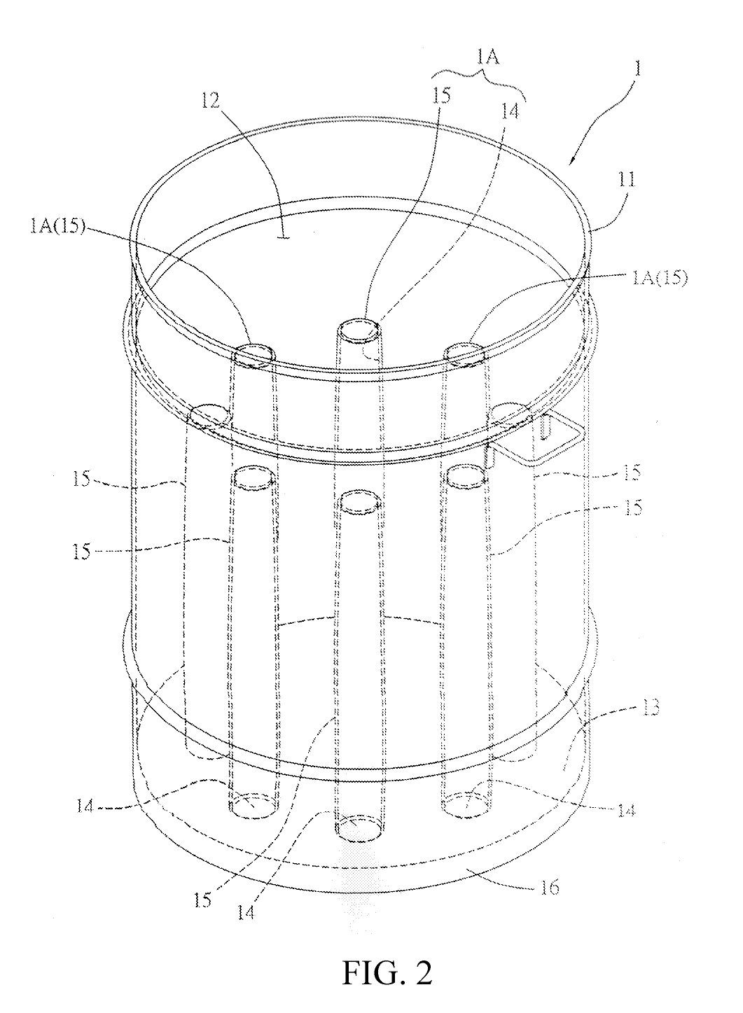

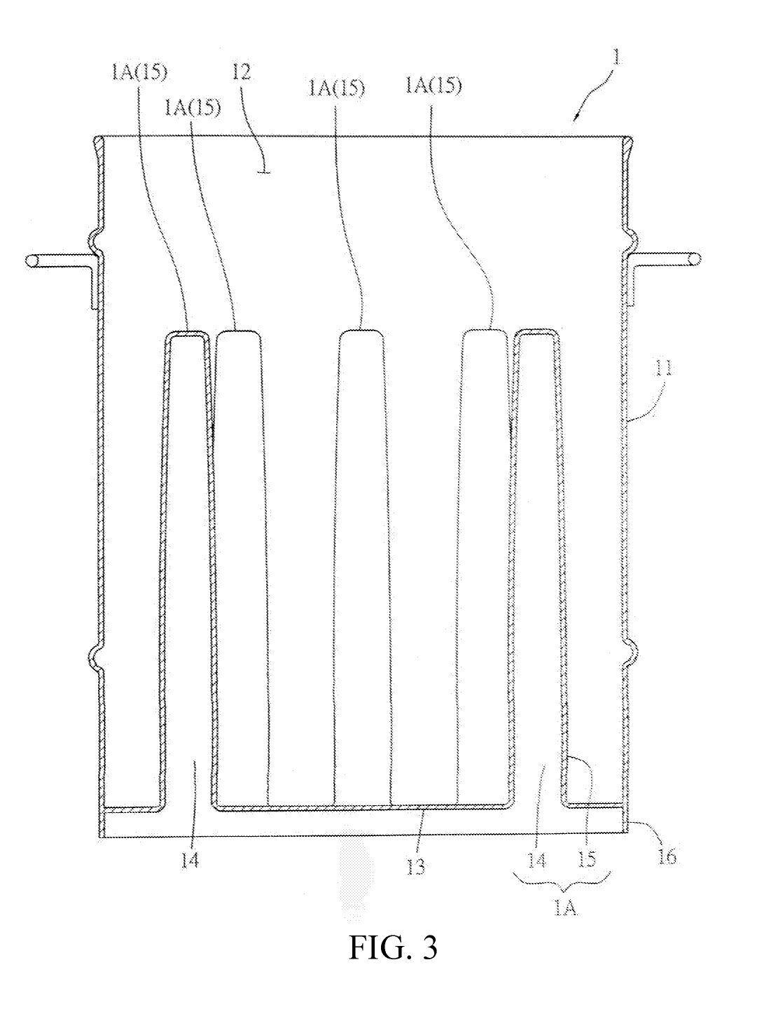

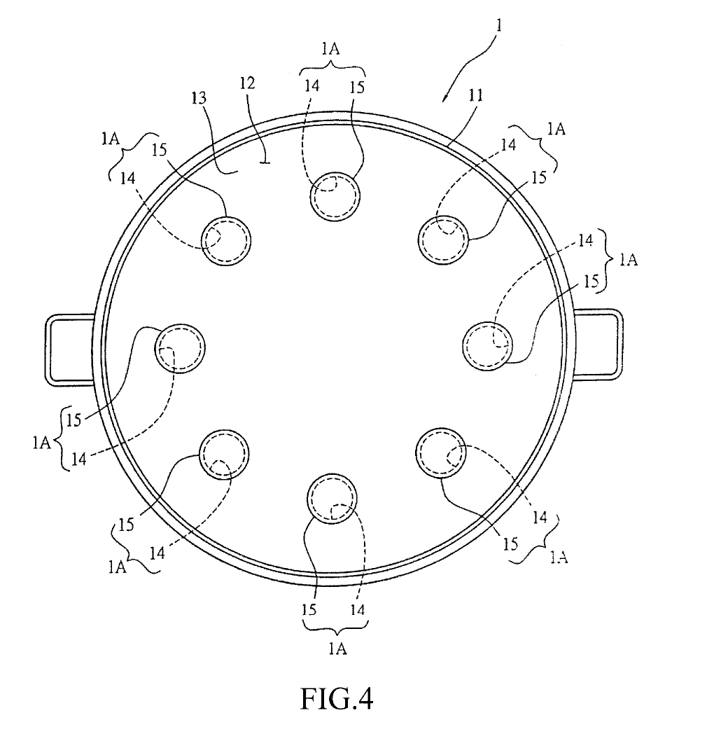

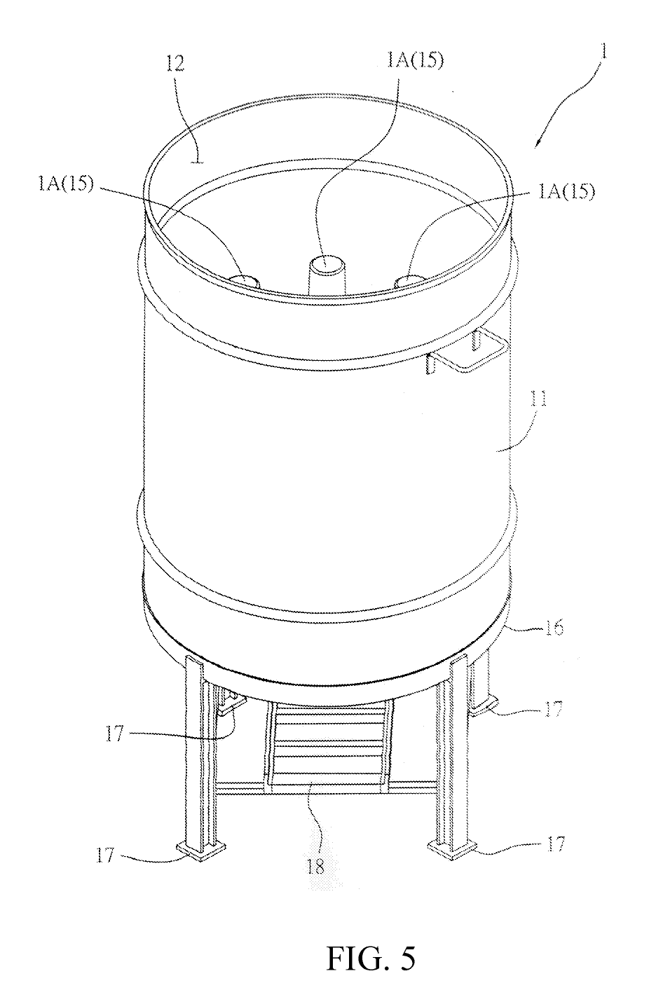

Please refer to FIGS. 2, 3, 4, 5 and 6, respectively showing the perspective view of the high-speed energy saving container apparatus, cross sectional view of the high-speed energy saving container apparatus, top view of the high-speed energy saving container apparatus, schematic view of the high-speed energy saving container apparatus equipped with a foot stand and a schematic view of the high-speed energy saving container apparatus under heating. The present invention provides a high-speed energy saving container apparatus 1, and the high-speed energy saving container apparatus 1 comprises at least one vertical container unit 11. The vertical container unit 11 includes at least one chamber 12 formed therein. The vertical container 11 further includes at least one bottom portion 13 formed underneath thereof, and the bottom portion 13 includes at least one heat accumulation recesses 14 protruded upward therefrom. The outer edge of each one of the heat accumulation recesses 14 includes at least one thermal conductive shield 15 extended upward into the chamber 12, as shown in FIGS. 2 and 3.

Accordingly, the bottom portion 13 includes at least one column 1A formed thereon and arranged uniformly to circumference the bottom portion 13. In addition, a lower side of the bottom portion 13 further comprises the heat accumulation recesses 14 uniformly distributed thereon to circumference the bottom portion 13. Accordingly, each of the heat accumulation recesses 14 and each of the thermal conductive shields 15 together form the column A, as shown in FIGS. 2 and 3.

Furthermore, the reinforcement ring 16 includes four foot stands 17 extended downward therefrom. A furnace rack 18 is horizontally attached among the foot stands 17, and a furnace firing head 2 for heating the high-speed energy saving container apparatus 1 is installed on the furnace rack 18.

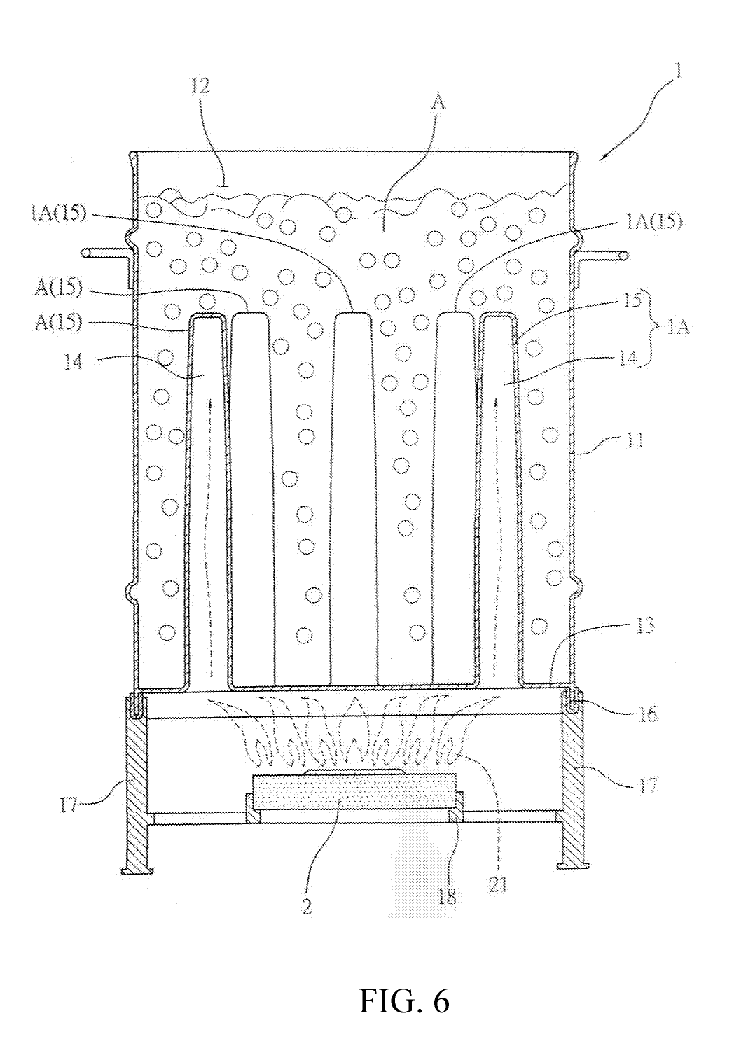

During the use of the high-speed energy saving container apparatus 1, a large amount of water A is poured into the chamber 12, and the furnace firing head 2 is switched on to provide heating flame 21 for heating the bottom portion 13 and the thermal conductive shields 15 of the heat accumulation recesses 14 until the water A inside the chamber 12 boils. The working principle is to transfer the thermal energy generated from the heating flame 21 to the water A via the bottom portion 13 and the thermal conductive shields 15 directly, and the thermal conductive shields 15 vertically protruded inside the chamber 12 are able to increase the heat transfer surface area in contact with the water A; therefore, the flame thermal point inside the heat conductive shields 15 can be increased along with the increase of the surface area thereof. As a result, the water A inside the chamber 12 can be boiled swiftly. According to the heat exchange model calculation and based on an exemplary experiment of a small thermal conductive shields 15 having the volume of diameter of 60 cm and height of 60 cm=>(30 cm)²π×60 cm×95%=161164 cubic cm=161 liter (water A); and in this exemplary experiment, 8 units of thermal conductive shields 15 are used, and the volume is =(5 cm)²×π×45 cm×8 units=approximately 28074 cubic cm≈28 liter; and 161 liter−28 liter=133 liter (water A). Therefore, with the use of dual-pipe instant heating flame 21, the water temperature can be heated from 25° C. to 100° C. within approximately 30 minutes, as shown in FIG. 6.

The principle and operation sequence of the present invention is:

1. Manufacture at least one thermal conductive shields 15 uniformly in order to increase the flame height (temperature) and to increase the contact surface area with the flame.

2. Provide sufficient height and space between the heating flame 21 and the bottom portion 12 in order to have adequate amount of oxygen exposure.

3. Use the vertical height and shape of the heat conductive shields to increase the flame height; therefore, under the same condition of heat source, since the flame height can be increased, the effect of temperature increase can be achieved such that it is of the profound advantage of saving the fuel consumption and shortening the water boiling time.

4. Use at least one vertical thermal conductive shields manufactured to uniformly distribute and circumference the bottom portion, the flame can form a uniform and concentrated heat source to rise upward (forming a flame upward rising effect) in order to prevent the dissipation of thermal energy; therefore, the outstanding outcome of entropy high-speed conduction and conversion into physical thermal dynamic energy can be achieved.

5. The water A inside the container 12 receives the heat transferred from the bottom portion 13 and the surrounding of the columns 1A (thermal conductive shields 15) as well as the tops of the columns 1A. Therefore, the top, bottom and surrounding of the circular columns inside the chamber 12 can generate fast current of the water A and perform heat exchange in order to increase the temperature of water A inside the chamber 12 rapidly and to achieve the outstanding effect of the high-speed energy saving container apparatus capable of saving the fuel (gas) consumption thereof, requiring only ¼ of the water boiling time of conventional container, as shown in FIG. 6.

In view of the above, the present invention provides a high-speed energy saving container apparatus 1 capable of using the heat accumulation recesses 14 formed thereon to integrally transfer heat to the thermal conductive shields 15 in order to transfer the heat to the water A inside the chamber 12 directly. With the thermal conductive shields 15 vertically protruded inside the chamber 12, the volume and quantity of the thermal conductive shields 15 can be increased according to the amount of the water A such that the flame height and thermal energy can be increased in order to rapidly boil the water A. According to the aforementioned exemplary experiment, the temperature of the water A can be boiled from the temperature of 25° C. to 100° C. within 30 minutes. Therefore, the present invention is able to save a great amount of energy cost and to achieve the primary objective of increasing the time efficiency and benefit.

I claim:

1. A high-speed energy saving container apparatus, comprising:
at least one vertical container unit having at least one chamber formed therein and at least one bottom portion formed underneath thereof; and
wherein the bottom portion includes at least one heat accumulation recess formed thereon, and an outer edge of each one the heat accumulation recess includes at least one thermal conductive shield extended upward into the chamber.

2. The high-speed energy saving container apparatus according to claim 1, wherein the bottom portion further comprises at least one column formed thereon and arranged uniformly to circumference the bottom portion; a lower side of the bottom portion further comprises the heat accumulation recesses uniformly distributed thereon to circumference the bottom portion; and each of the heat accumulation recesses and each of the thermal conductive shields together form the column.
